(19) United States
(12) Patent Application Publication
(10) Pub. No.: US 2014/0029642 A1
(43) Pub. Date: Jan. 30, 2014

(54) ROOF FOR LADLE FURNACE

(71) Applicant: HYUNDAI STEEL COMPANY, Incheon (KR)

(72) Inventor: Sang-Hoon Lee, Pohang (KR)

(73) Assignee: HYUNDAI STEEL COMPANY, Incheon (KR)

(21) Appl. No.: 14/040,410

(22) Filed: Sep. 27, 2013

Related U.S. Application Data
(63) Continuation of application No. PCT/KR2011/010140, filed on Dec. 27, 2011.

(30) Foreign Application Priority Data
Mar. 30, 2011 (KR) 10-2011-0028502
Apr. 28, 2011 (KR) 10-2011-0040072
Nov. 24, 2011 (KR) 10-2011-0123651

(51) Int. Cl. F27D 17/00

(52) U.S. Cl. CPC F27D 17/003
USPC 373/8; 373/73

(57) ABSTRACT

The present invention relates to a roof for a ladle furnace which can be compatible with a dust collection elbow or with a dust collection hood. The roof according to the present invention includes a side part (102) which has a vertical cylindrical shape, and a cover part (104) which covers an upper end of the side part. A first seating hole (110) is formed in a central portion of the cover part, and a second seating hole (112) is formed in the cover part at a position adjacent to the first seating hole. A small ceiling (160) or a dust collection hood (170) is selectively seated into the first seating hole. A dust collection elbow (180) or a water cooling panel (190) is selectively seated into the second seating hole.

### CROSS-REFERENCE TO RELATED APPLICATIONS

The present application is a continuation application of International Application No. PCT/KR2011/010140 filed on Dec. 27, 2011, which claims priority to Korean Application Nos. KR 10-2011-0028502 filed on Mar. 30, 2011, KR 10-2011-0040072 filed on Apr. 28, 2011, and KR 10-2011-0123651 filed on Nov. 24, 2011, which applications are incorporated herein by reference.

### TECHNICAL FIELD

The present invention relates, in general, to roofs for ladle furnaces and, more particularly, to a roof for a ladle furnace which can be compatible with a dust collection elbow or a dust collection hood depending on operating conditions.

### BACKGROUND ART

A steel manufacturing process in which steel is manufactured using iron ore as raw material begins with an ironmaking operation of melting iron on in a shaft furnace. Molten iron which is formed by melting iron on undergoes a primary refining process of successively conducting operations such as dephosphorization, decarburization, deoxidation, etc. and removing impurities from the molten iron, thus forming molten steel.

Molten steel from which impurities have been removed is treated through a secondary refining process, whereby fine component adjustment is realized. Subsequently, the molten steel is transferred to a continuous casting process.

Thereafter, a half-finished product is formed through the continuous casting process. The half-finished product is shaped by a final forming operation such as rolling, thus forming a final product.

An LF (ladle furnace) is a device which is used to finely adjust components of molten steel and desulfurize it after the melting of scrap and the primary refining process are conducted by an electric furnace.

In the ladle furnace, a secondary refining process of adjusting components of molten steel is conducted to make it appropriate for desulfurization and deoxidation in such a way that supplementary material is added to molten steel and then it is treated by Ar bubbling and is arc-heated.

An example of the prior art was proposed in Korean Patent Registration No. 1026515 (Registration date: Mar. 25, 2011, title: Roof device for ladle furnace).

### SUMMARY

Accordingly, the present invention has been made keeping in mind the above problems occurring in the prior art, and an object of the present invention is to provide a roof for a ladle furnace which covers an upper end of the ladle furnace and is able to be compatible with a dust collection elbow or a dust collection hood depending on operating conditions.

The objects of the present invention are not limited to the above object.

In order to accomplish the above object, the present invention provides a roof for a ladle furnace, including: a side part having a vertical cylindrical shape; and a cover part covering an upper end of the side part, with a first seating hole formed in a central portion of the cover part, and a second seating hole formed in the cover part at a position adjacent to the first seating hole, wherein a small ceiling or a dust collection hood is selectively seated into the first seating hole, and a dust collection elbow or a water cooling panel is selectively seated into the second seating hole.

The roof may further include: a plurality of first cotter bodies vertically protruding from the cover part at positions adjacent to the first seating hole so that the small ceiling or the dust collection hood is selectively fastened to the first cotter bodies; and a plurality of second cotter bodies vertically protruding from the cover part at positions adjacent to the second seating hole so that the dust collection elbow or the water cooling panel is selectively fastened to the second cotter bodies.

The dust collection hood may have: a third seating hole formed in an upper portion of the dust collection hood so that the small ceiling is seated into the third seating hole; and a plurality of third cotter bodies to which the small ceiling that is seated into the third seating hole is fastened, wherein the third cotter bodies vertically protrude from the dust collection hood at positions adjacent to the third seating hole.

The cover part may include a carbon supply port provided adjacent to the first seating hole, and the side part may comprise a sampling supply port, wherein each of the carbon supply port and the sampling supply port may include: a portion cover; and a port control unit vertically opening or closing the port cover.

The port control unit may include: an opening control cylinder; a fixed bracket extending from an outer surface of the carbon supply port or the sampling supply port towards the port cover; and a rotating bracket extending from the port cover, the rotating bracket being rotatably coupled to the fixed bracket by a hinge, wherein an extension end of the rotating bracket is connected to an extension end of a cylinder rod of the opening control cylinder.

According to the present invention, a single roof for a ladle furnace can be compatible with a dust collection elbow or a dust collection hood depending on operating conditions. Therefore, the present invention can solve the conventional problem in which the entirety of the roof must be replaced with another when operating conditions are changed. In addition, because it is not required to manufacture different kinds of roofs that correspond to all operating conditions, the production cost related to manufacture of the roof can be reduced.

Furthermore, port covers which are provided on an opening of a carbon support port and an opening of a sampling supply port are configured such that they are respectively rotated by opening control cylinders in the directions facing the openings of the carbon supply port and the sampling supply port. Therefore, even if each port cover is deformed by heat transferred from the ladle furnace, the opening or closing operation can be precisely conducted.

### BRIEF DESCRIPTION OF DRAWINGS

FIG. 1 is a perspective view illustrating a roof for a ladle furnace, according to the present invention,

FIG. 2 is a plan view illustrating the ladle furnace roof of FIG. 1,

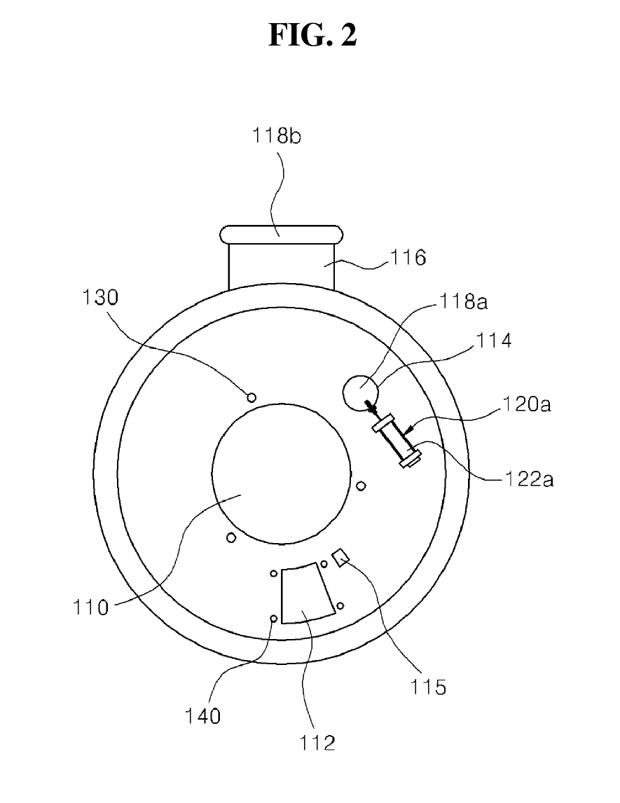

FIG. 3 is a view showing a dust collection elbow and a small ceiling that are provided on the ladle furnace roof of FIG. 1,

FIG. 4 is a view showing a dust collection hood provided on the ladle furnace roof of FIG. 1,

FIG. 5A is an enlarged perspective view of a carbon supply port shown in FIG. 1, and

FIG. 5B is an enlarged perspective view of a sampling supply port shown in FIG. 1.

### DETAILED DESCRIPTION

Hereinafter, the present invention will be described with reference to the attached drawings. Reference should now be made to the drawings, in which the same reference numerals are used throughout the different drawings to designate the same or similar components. If detailed descriptions of well-known functions or configurations would unnecessarily obfuscate the gist of the present invention, the detailed descriptions will be omitted.

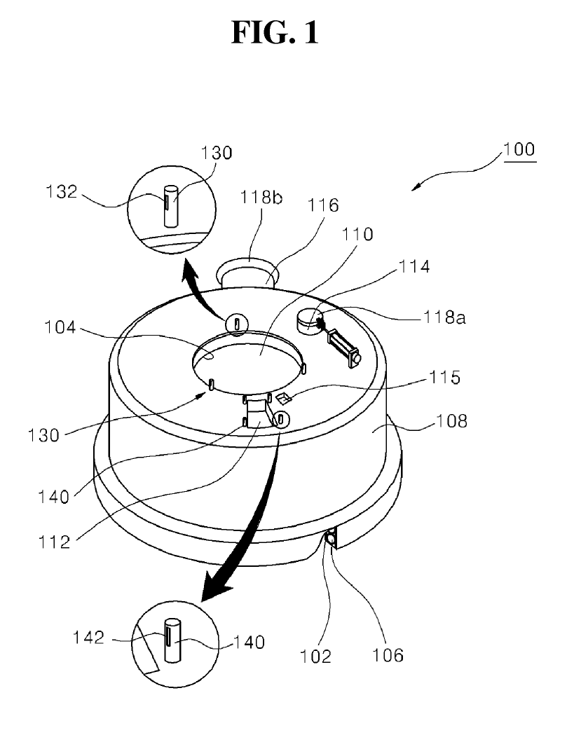

FIG. 1 is a perspective view illustrating a roof for a ladle furnace, according to the present invention. The ladle furnace roof 100 according to the present invention has a side part 102 which has a vertical cylindrical shape, and a cover part 104 which covers an open upper end of the side part 102. The ladle furnace roof 100 is installed to cover the upper end of the ladle furnace (not shown).

The ladle furnace roof 100 covers the upper end of he ladle furnace and functions to remove impure elements (sulfur, gas, etc.) generated in the ladle furnace during refining operation and protect the surroundings from melt or slag that spatters during the operation.

A small ceiling into which electrodes are inserted is seated in the ladle furnace roof 100. A carbon supply port, an auxiliary raw material supply hole, a sampling supply port, etc. are installed around the small ceiling. Furthermore, ladle furnace roofs are classified into a roof provided with a dust collection elbow or a roof provided with a dust collection hood for sucking impure elements generated in the ladle furnace and discharging them from the ladle furnace.

The present invention provides a ladle furnace roof which can be compatible with a dust collection elbow or with a dust collection hood depending on operating conditions, in other words, whether to prevent the electrodes installed in the small ceiling from being damaged or worn or to obtain superior dust collection effect.

As shown in FIG. 1, a cooling pipe 106 is provided in the side part 102 and the cover part 104 so as to cool heat generated from the ladle furnace. The outer surfaces of the side part 102 and the cover part 104 are covered with a shell 108. A cooling water supply pipe (not shown) and a cooling water discharge pipe (not shown) are connected to the cooling pipe 106.

The sampling supply port 116 is provided at a predetermined position in the side part 102. A first seating hole 110, a second seating hole 112, a carbon supply port 114, and an auxiliary raw material supply hole 115 are formed in the cover part 104. The first seating hole 110 is formed in a central portion of the cover part 104. The second seating hole 112, the carbon supply port 114 and the auxiliary raw material supply hole 115 are provided in the cover part 104 at positions adjacent to the first seating hole 110.

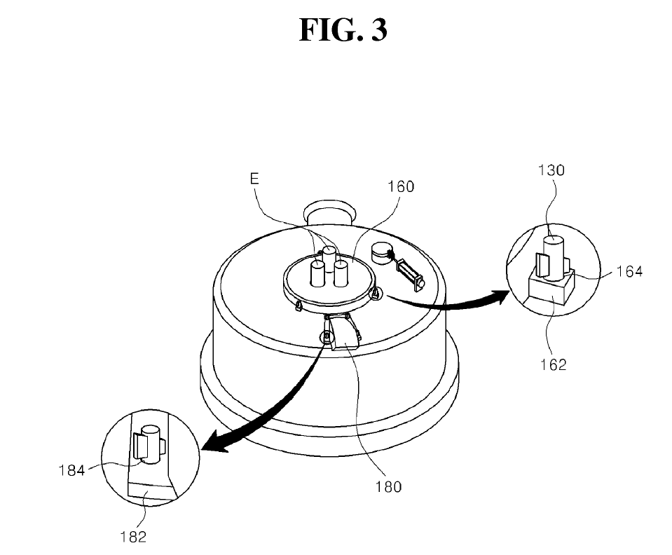

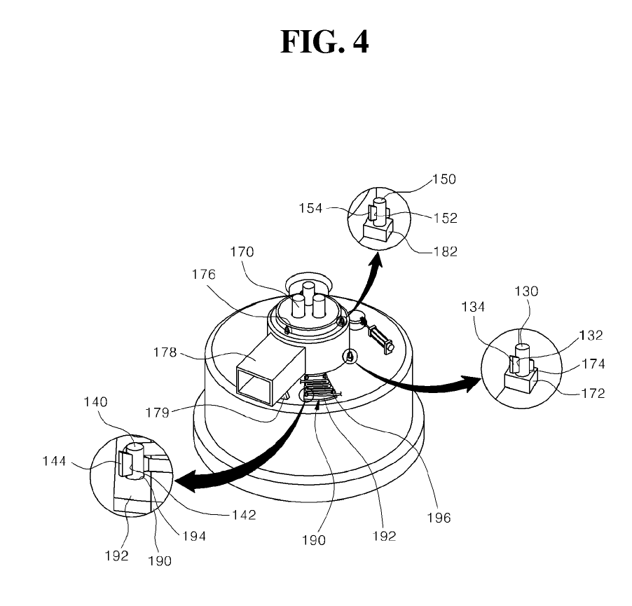

As shown in FIGS. 3 and 4, depending on operating conditions, a small ceiling 160 provided with electrodes E and a dust collection elbow 180, or a dust collection hook 170 provided with a small ceiling 160 and a water cooling panel 190 are selectively provided in the cover part 104. For example, in operation for preventing the electrodes E installed in the small ceiling 160 from being damaged or worn, the small ceiling 160 and the dust collection elbow 180 are respectively seated into the first seating hole 110 and the second seating hole 112 and fastened to the cover part 104. In operation for obtaining superior dust collection effect, the dust collection hood 170 and the water cooling panel 190 are respectively seated into the first seating hole 110 and the second seating hole 112 and fastened to the cover part 104. A plurality of first cotter bodies 130 vertically protrude from the cover part 104 around the first seating hole 110 so that the small ceiling 160 or the dust collection hood 170 can be fastened to the cover part 104 by the first cotter bodies 130. A plurality of second cotter bodies 140 vertically protrude from the cover part 104 around the second seating hole 112 so that the dust collection elbow 180 or the water cooling panel 190 is fastened to the cover part 104 by the second cotter bodies 140. A small ceiling connection flange 162 that has insert holes 164 and a hood connection flange 172 that has insert holes 174 are respectively provided on the small ceiling 160 and the dust collection hood 170, wherein the first cotter bodies 130 are inserted into the respective insert holes 164 or 174. In the same manner, an elbow connection flange 182 that has insert holes 184 and a water cooling panel connection flange 192 that has insert holes 194 are respectively provided on the dust collection elbow 180 and the water cooling panel 190, wherein the second cotter bodies 140 are inserted into the respective insert holes 184 or 194. The small ceiling connection flange 162 or the hood connection flange 172 that is fitted over the first cotter bodies 130 is fastened to the first cotter bodies 130 by cotter pins 134 that are inserted into corresponding cotter holes 132 formed in the respective first cotter body 130. The elbow connection flange 182 or the water cooling panel connection flange 192 that is fitted over the second cotter bodies 140 is fastened to the second cotter bodies 140 by cotter pins 144 that are inserted into corresponding cotter holes 142 formed in the respective second cotter body 140.

A third seating hole 176 is formed in an upper portion of the dust collection hood 170 that is fastened to the first cotter bodies 130, and the small ceiling 160 provided with the electrodes E is seated into the third seating hole 176. A plurality of third cotter bodies 150 for fixing the small ceiling 160 to the dust collection hood 170 vertically protrude from the dust collection hood 170 at positions adjacent to the third seating hole 176. In the same manner, the insert holes 164 formed in the small ceiling connection flange are fitted over the respective third cotter bodies 150, and the small ceiling connection flange 162 that is fitted over the third cotter bodies 150 is fastened to the third cotter bodies 150 by cotter pins 154 that are inserted into corresponding cotter holes 152 formed in the respective third cotter body 150.

When the dust collection hood 170 is fixed in the first seating hole 110, at least one support block 179 is provided between the cover part 104 and the exhaust duct 178 that is provided on an outer circumferential surface of the dust collection hood 170 so that the exhaust duct 178 can be supported by the support block 179. Furthermore, when the dust collection hood 170 is fixed in the first seating hole 110, a panel cooling pipe 196 is arranged on the water cooling panel 190, which covers the second seating hole 112, so as to cool heat transferred from the ladle furnace. As can be easily appreciated, a cooling water supply pipe (not shown) and a cooling water discharge pipe (not shown) are connected to the panel cooling pipe 196.

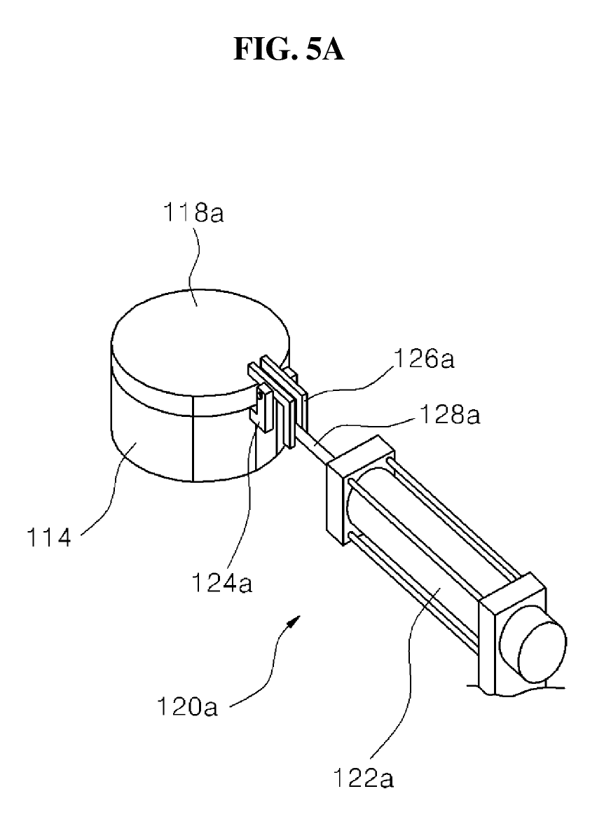

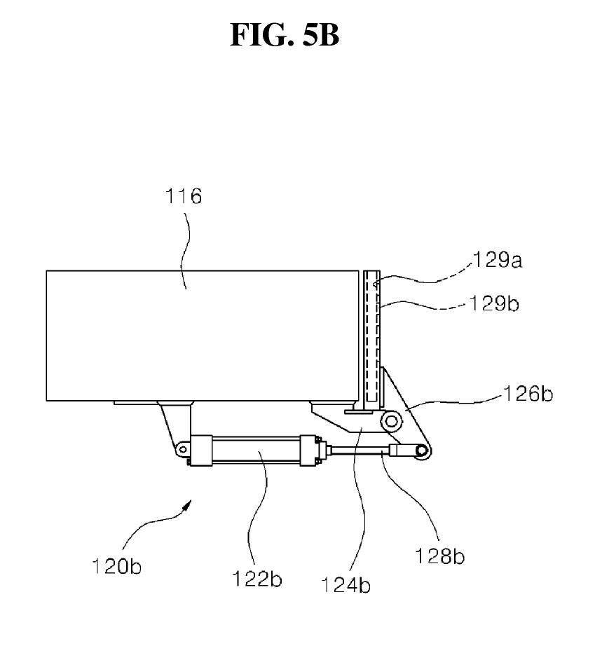

Meanwhile, as shown in FIGS. 5A and 5B, port covers 118a and 118b and port control units 120a and 120b are respectively provided on the sampling supply port 116 formed in the side part 102 and the carbon supply port 114 formed in the cover part 104.

The port covers 118a and 118b respectively open or close an opening of the carbon supply port 114 and an opening of the sampling supply port 116. The port covers 118a and 118b are respectively coupled to the carbon supply port 114 and the sampling supply port 116 so as to be rotatable in directions facing the openings of the carbon supply port 114 and the sampling supply port 116. The port covers 118a and 118b are respectively opened or closed by the port control units 120a and 120b.

The port control units 120a and 120b respectively include opening control cylinders 112a and 122b which are disposed adjacent to the carbon supply port 114 and the sampling support port 116. The port control units 120a and 120b further respectively include fixed brackets 124a and 124b which respectively extend from the outer surfaces of the carbon supply port 114 and the sampling supply port 116 towards the corresponding port covers 118a and 118b, and rotating brackets 126a and 126b which respectively extend from the port covers 118a and 118b and are rotatably coupled to the corresponding fixed brackets 124a and 124b by hinges. Extension ends of the rotating brackets 126a and 126b are respectively connected to cylinder rods 128a and 128b which are extended from or contracted into the opening control cylinders 122a and 122b. That is, when the cylinder rods 128a and 128b which are respectively connected to the rotating brackets 126a and 126b are contracted by the operation of the opening control cylinders 122a and 122b, the port covers 118a and 118b respectively open the carbon supply port 114 and the sampling supply port 116. When the cylinder rods 128a and 128b are extended by the operation of the opening control cylinders 122a and 122b, the port covers 118a and 118b respectively close the carbon supply port 114 and the sampling supply port 116.

Meanwhile, a cooling passage (not shown) is formed in the port cover 118a of the carbon supply port 114 to cool heat transferred from the ladle furnace. The port cover 118b of the sampling supply port 116 which receives heat from the ladle furnace is cooled by an air-cooling method. For this, an air-cooling passage 129a through which air flows and a plurality of air holes 129b connected to the air-cooling passage 129a are formed in the port cover 118b of the sampling supply port 116.

The ladle furnace roof 100 according to the present invention can be compatible with the dust collection elbow 180 or the dust collection hood 170 depending on operating conditions. Therefore, the present invention can solve the conventional problem in which the entirety of the roof 100 must be replaced with when operating conditions are changed. In addition, because it is not required to manufacture different kinds of roofs that correspond to differing operating conditions, the production cost related to manufacture of the roof 100 can be reduced.

Furthermore, in the present invention, the port covers 118a and 118b which are provided on the opening of the carbon support port 114 and the opening of the sampling supply port 116 are configured such that they are respectively rotated by the opening control cylinders 122a and 122b in the directions facing the openings of the carbon supply port 114 and the sampling supply port 116. Therefore, even if the port cover 118a or 118b is deformed by heat transferred from the ladle furnace, the opening or closing operation can be precisely conducted.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

<Description of the Reference Numerals in the Drawings>

| 100: roof for ladle furnace | 102: side part |
|---|---|
| 104: cover part | 110: first seating hole |
| 112: second seating hole | 114: carbon supply port |
| 116: sampling supply port | 118a, 118b: port cover |
| 122a, 122b: opening control cylinder | |
| 130: first cotter body | |
| 140: second cotter body | 150: third cotter body |
| 160: small ceiling | 170: dust collection hood |
| 180: dust collection elbow | 190: water cooling panel |

1. A roof for a ladle furnace, comprising:
a side part having a vertical cylindrical shape; and
a cover part that covers an upper end of the side part,
wherein a first seating aperture is formed in a central portion of the cover part and a second seating aperture is formed in the cover part at a position adjacent to the first seating aperture,
wherein a ceiling or a dust collection hood is selectively seated into the first seating aperture, and
a dust collection elbow or a water cooling panel is selectively seated into the second seating aperture.

2. The roof for a ladle furnace of claim 1, further comprising:
a plurality of first cotter bodies that vertically protrude from the cover part at positions adjacent to the first seating aperture to selectively fasten the ceiling or the dust collection hood to the first cotter bodies; and
a plurality of second cotter bodies that vertically protrude from the cover part at positions adjacent to the second seating aperture to selectively fasten the dust collection elbow or the water cooling panel to the second cotter bodies.

3. The roof for a ladle furnace of claim 1, wherein the dust collection hood includes:
a third seating aperture formed in an upper portion of the dust collection hood to seat the ceiling into the third seating aperture; and
a plurality of third cotter bodies to which the ceiling that is seated into the third seating aperture is fastened,
wherein the third cotter bodies vertically protrude from the dust collection hood at positions adjacent to the third seating aperture.

4. The roof for a ladle furnace of claim 2, wherein
the ceiling includes a ceiling connection flange that has insert bores to be fitted over the respective first cotter bodies,
the dust collection hood includes a hood connection flange that has insert bores to be fitted over the respective first cotter bodies, and
each of the dust collection elbow and the water cooling panel includes an elbow connection flange that has insert bores to be fitted over the respective second cotter bodies.

5. The roof for a ladle furnace of claim 3, wherein the ceiling includes a ceiling connection flange that has insert bores to be fitted over the respective third cotter bodies.

6. The roof for a ladle furnace of claim 4, wherein the ceiling connection flange or the hood connection flange that is fitted over the first cotter bodies and the elbow connection flange or the water cooling panel connection flange that is fitted over the second cotter bodies are fastened to the corresponding cotter bodies by cotter pins inserted into corresponding cotter bores that are respectively formed in the first and second cotter bodies.

7. The roof for a ladle furnace of claim 5, wherein the ceiling connection flange that is fitted over the third cotter bodies is fastened to the third cotter bodies by cotter pins inserted into corresponding cotter bores that are respectively formed in the third cotter bodies.

8. The roof for a ladle furnace of claim 1, wherein at least one support block is disposed between an exhaust duct of the dust collection hood and the cover part to support the exhaust duct by the support block.

9. The roof for a ladle furnace of claim 1, further comprising:
a cooling pipe is disposed on the water cooling panel to cool heat transferred from the ladle furnace.

10. The roof for a ladle furnace of claim 1, wherein
the cover part includes a carbon supply port disposed adjacent to the first seating aperture, and
the side part includes a sampling supply port.

11. The roof for a ladle furnace of claim 10, wherein
each of the carbon supply port and the sampling supply port includes a portion cover and a port controller configured to vertically open or close the port cover.

12. The roof for a ladle furnace of claim 11, wherein the port controller includes:
an opening control cylinder;
a fixed bracket that extends from an outer surface of the carbon supply port or the sampling supply port towards the port cover; and
a rotating bracket that extends from the port cover, the rotating bracket being rotatably coupled to the fixed bracket by a hinge, wherein an extension end of the rotating bracket is connected to an extension end of a cylinder rod of the opening control cylinder.

13. The roof for a ladle furnace of claim 11, wherein
a cooling passageway is formed in the port cover of the carbon supply port to cool the heat transferred from the ladle furnace, and
an air-cooling passageway is formed in the port cover of the sampling supply port to cool the heat transferred from the ladle furnace.
